(19) United States
(12) Patent Application Publication
(10) Pub. No.: US 2026/0184265 A1
(43) Pub. Date: Jul. 2, 2026

(54) SENSOR HOLDER FOR VEHICLE AND METHOD OF MOUNTING THE SAME

(71) Applicants: HYUNDAI MOTOR COMPANY, Seoul (KR); Kia Corporation, Seoul (KR); CAMS Co., Ltd., Gwangju (KR)

(72) Inventors: Ho-Jeong CHOI, Hwaseong-si (KR); Hyun-Seung HWANG, Hwaseong-si (KR); Woo-Chul JEONG, Gwangju (KR); Hwan JEONG, Gwangju (KR)

(21) Appl. No.: 19/297,382

(22) Filed: Aug. 12, 2025

(30) Foreign Application Priority Data
Dec. 26, 2024 (KR) 10-2024-0197151

(51) Int. Cl. B60R 11/00; B60R 19/02; G01D 11/24

(52) U.S. Cl. CPC B60R 11/00; G01D 11/245; B60R 2011/004; B60R 2011/0052; B60R 19/023

(57) ABSTRACT

A sensor holder for a vehicle includes a sensor mounting portion configured to mount a sensor therein, a flange portion extending from an outer surface of the sensor mounting portion in a direction perpendicular to an axial direction of the sensor mounting portion, and a gripping portion that extends parallel to the flange portion, where the gripping portion extends from the sensor mounting portion to an outside of the sensor mounting portion.

### CROSS-REFERENCE TO RELATED APPLICATION

This application claims priority to Korean Patent Application No. 10-2024-0197151, filed on Dec. 26, 2024, the disclosure of which is incorporated herein by reference in its entirety.

### TECHNICAL FIELD

The present disclosure relates to a sensor holder for a vehicle used for mounting a sensor on an exterior of the vehicle, and a method of mounting the same, and more particularly, to a sensor holder for a vehicle and a method of mounting the same, which can secure the sensor to the vehicle without undergoing a process such as fusion.

### BACKGROUND

A sensor may be mounted on an exterior of a vehicle for driving assistance, parking assistance, and the like. For example, a parking sensor may be mounted on a bumper or a side garnish of the vehicle to identify an object in the vicinity during parking and provide a parking distance alert to a driver, or to enable remote parking.

In some cases, the parking sensor is mounted to a sensor holder after pre-mounting the sensor holder to the bumper or the side garnish of the vehicle. For example, the sensor holder may be mounted to the bumper or the side garnish through fusion. As such, a separate fusion process may be performed to mount the sensor holder, where the addition of the fusion process may increase production costs. In some cases, a fusion jig may be provided to mount the sensor holder through fusion, where the fusion jig may be manufactured for each vehicle model and location, which may include production costs.

### SUMMARY

The present disclosure describes a sensor holder for a vehicle and a method of mounting the same, which enable an operator to mount the sensor holder manually without undergoing a fusion process.

According to one aspect of the subject matter described in this application, a sensor holder for a vehicle includes a sensor mounting portion configured to support a sensor, a flange portion that extends outward from the sensor mounting portion, and a gripping portion that extends from the sensor mounting portion and is parallel to the flange portion. The flange portion and the gripping portion are configured to, based on the gripping portion passing through an exterior panel of the vehicle and then being rotated with respect to the exterior panel, come into contact with surfaces of a securing portion of the exterior panel to thereby fix the sensor holder to the exterior panel of the vehicle.

Implementations according to this aspect can include one or more of the following features. For example, the sensor holder of claim 1, can further include a fastening bolt that is configured to pass through at least a portion of the gripping portion and be fastened to the gripping portion, where the fastening bolt is configured to secondarily fix the sensor holder to the exterior panel of the vehicle. In some implementations, the sensor holder can further include an assembly handle that protrudes from the gripping portion. In some examples, the assembly handle defines an opening and a thread in the opening, wherein the fastening bolt is configured to be threadedly coupled to the thread of the assembly handle.

In some implementations, the sensor holder can further include a reinforcing rib that is disposed at the gripping portion and protrudes from the gripping portion. In some examples, the sensor holder can further include a sensor guard that is disposed at an end of the sensor mounting portion and configured to surround a periphery of the sensor. In some examples, the sensor guard can be connected to the reinforcing rib.

In some implementations, the sensor holder can further include a plurality of gripping portions that are spaced apart from the flange portion. In some examples, the plurality of gripping portions can be arranged at intervals along a periphery of the sensor mounting portion. In some implementations, the flange portion can define a garnish fastening hole configured to couple to a hook that protrudes from a side garnish of the vehicle, where the hook of the side garnish of the vehicle is configured to pass through and engage with the garnish fastening hole.

According to another aspect, a method for mounting a sensor holder for a vehicle includes positioning the sensor holder to be aligned with a sensor mounting hole defined at an exterior panel of the vehicle, inserting the sensor holder into the sensor mounting hole, and rotating the sensor holder relative to the exterior panel to position a gripping portion of the sensor holder to a securing portion of the exterior panel, where the securing portion is disposed between sub through-holes that are defined at a periphery of the sensor mounting hole.

Implementations according to this aspect can include one or more of the following features. For example, the method can further include after rotating the sensor holder relative to the exterior panel, fastening the sensor holder to the exterior panel through a fastening bolt. In some examples, fastening the sensor holder to the exterior panel can include inserting the fastening bolt to an opening of an assembly handle of the sensor holder and fastening the fastening bolt to a thread in the opening of the assembly handle.

In some implementations, positioning the sensor holder can include aligning the gripping portion with one of the sub through-holes. In some examples, rotating the sensor holder can include rotating the sensor holder to bring the gripping portion and a flange portion of the sensor holder into contact with surfaces of the securing portion of the exterior panel. In some implementations, rotating the sensor holder can include rotating the sensor holder to align a garnish fastening hole defined at the sensor holder with one of the sub through-holes.

According to another aspect, a sensor holder for a vehicle includes a sensor mounting portion configured to couple a sensor to an exterior panel of the vehicle, a flange portion that extends from an outer surface of the sensor mounting portion in a radial direction perpendicular to an axial direction of the sensor mounting portion, a gripping portion that is spaced apart from the flange portion and extends parallel to the flange portion, the gripping portion extending from the sensor mounting portion to an outside of the sensor mounting portion, and an assembly handle that protrudes from the gripping portion. The flange portion and the gripping portion are configured to, based on the gripping portion passing through the exterior panel of the vehicle and then the assembly handle being rotated by an operator, come into contact with surfaces of a securing portion of the exterior panel to thereby fix the sensor holder to the exterior panel of the vehicle.

Implementations according to this aspect can include one or more of the following features. For example, the sensor holder can further include a sensor guard disposed at an end of the sensor mounting portion and configured to cover at least a portion of the sensor. In some implementations, the sensor mounting portion and the sensor guard can be configured to pass through a main through-hole that is defined at the exterior panel of the vehicle, where the gripping portion is configured to pass through a sub through-hole defined at the exterior panel of the vehicle, and the sub through-hole is defined at a periphery of the main through-hole and connected to the main through-hole.

In some implementations, the assembly handle can be configured to pass through a handle through-hole defined at the exterior panel of the vehicle, the handle through-hole being defined at the periphery of the main through-hole and connected to the main through-hole.

In some implementations, with the sensor holder for a vehicle and the method of mounting the same, an operator can mount the sensor holder manually on a vehicle without a tool such as a fusion jig.

The sensor holder can be used universally regardless of the vehicle model and mounting location, and thus a tool may not be provided for installing a sensor to each vehicle model and location, thereby reducing production costs.

### BRIEF DESCRIPTION OF THE DRAWINGS

FIG. 1 is a perspective view illustrating an example of a sensor holder for a vehicle.

FIG. 2 is a bottom perspective view illustrating the sensor holder.

FIG. 3 is a plan view illustrating the sensor holder.

FIG. 4 is a schematic view illustrating an example of a location on which the sensor holder is mounted.

FIG. 5 is an enlarged view of section A of FIG. 4.

FIG. 6 is a schematic view illustrating an example of a parking sensor mounted on a bumper of the vehicle by using the sensor holder.

FIG. 7 is a schematic view illustrating a state in which after mounting the parking sensor by using the sensor holder, finishing is performed with a side varnish.

FIG. 8 is a perspective view illustrating a state in which the sensor holder is being inserted into a sensor mounting hole of the bumper.

FIG. 9 is a rear view illustrating a state in which the sensor holder is inserted into the sensor mounting hole of the bumper.

FIG. 10 is a rear view illustrating a state in which the sensor holder has rotated in the sensor mounting hole of the bumper.

FIG. 11 is a perspective view illustrating a state in which a fastening bolt is being fastened to secure the sensor holder.

FIG. 12 is a front view illustrating a state in which the mounting of the sensor holder is completed using the fastening bolt.

FIG. 13 is a rear view illustrating a state in which a sensor is mounted on the sensor holder.

FIG. 14 is a rear view illustrating a state in which a side garnish is coupled to the bumper after the sensor is mounted on the sensor holder.

FIG. 15 is a flowchart illustrating a method for mounting the sensor holder.

### DETAILED DESCRIPTION

Hereinafter, a sensor holder for a vehicle and a method of mounting the same will be described in detail with reference to the accompanying drawings.

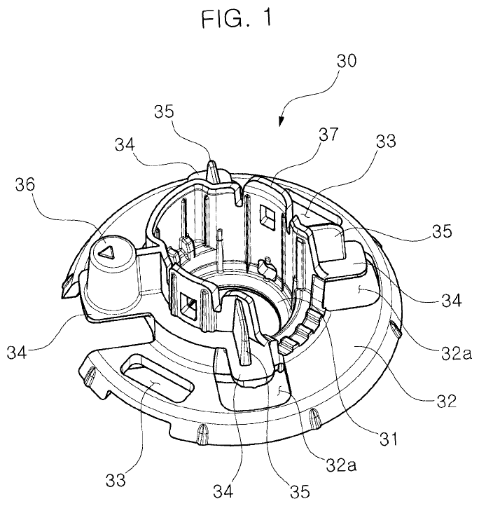

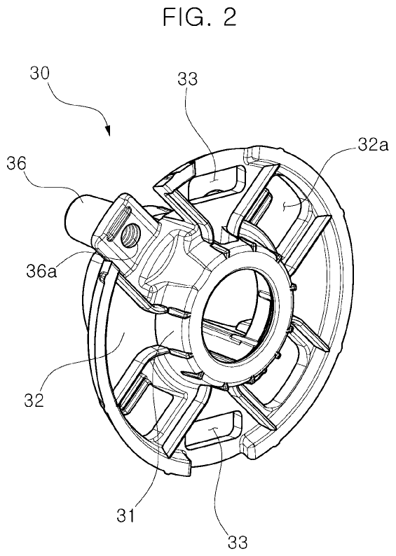

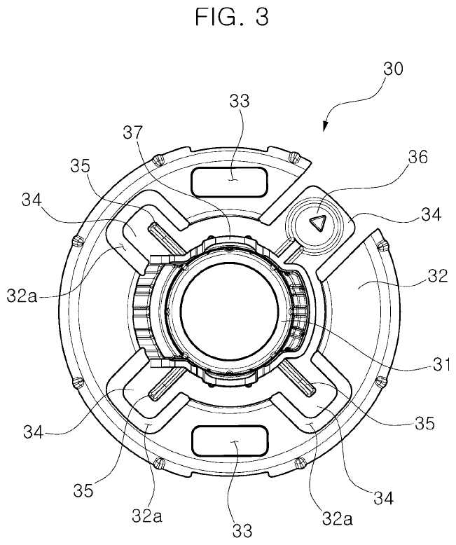

Referring to FIGS. 1 to 3, a sensor holder 30 for a vehicle includes: a sensor mounting portion 31 for mounting a sensor 40 mounted therein; a flange portion 32 extending outward, for example, from an outer surface of the sensor mounting portion 31 in a direction perpendicular to an axial direction of the sensor mounting portion 31; and a gripping portion 34 spaced apart from the flange portion 32 and extending in parallel with the flange portion 32 from the sensor mounting portion 31 to the outside of the sensor mounting portion 31. When the gripping portion 34 passes through an exterior panel 10 of a vehicle and then rotates, the flange portion 32 and the gripping portion 34 come into contact with both surfaces of a securing portion 12 formed in the exterior panel 10, respectively, thereby first securing the sensor holder to the exterior panel of the vehicle.

In the present disclosure, an example will be described in which after assembling a sensor holder 30 onto a bumper, which is an example of the exterior panel 10 of the vehicle, and mounting a parking sensor 40, which is an example of the sensor 40, on the sensor holder 30, finishing is performed with a side garnish 20, which is an example of a finish part.

The sensor mounting portion 31 can be configured to support the sensor 40, such as the parking sensor 40, mounted therein. The sensor mounting portion 31 can be open at both ends, and thus the sensor 40 can detect an external object even when the sensor 40 is installed inside the vehicle. For example, the sensor mounting portion 31 can be an opening configured to accommodate the sensor 40 or a wall that surrounds the opening.

The flange portion 32 can extend from the outer surface of the sensor mounting portion 31 in the direction (e.g., a radial direction) perpendicular to the axial direction of the sensor mounting portion 31.

The flange portion 32 is supported by coming into contact with one surface of the bumper when the sensor holder 30 is mounted on the bumper.

After the sensor holder 30 is mounted on the bumper and the sensor 40 is mounted on the sensor holder 30, a garnish fastening hole 33 for fastening the side garnish 20 is formed in the flange portion 32. The hook 21 formed in the side garnish 20 penetrates the garnish fastening hole 33, thereby causing the hook 21 to engage with the flange portion 32.

In some implementations, the gripping portion 34 can be parallel to the flange portion 32 and extend from the sensor mounting portion 31. The gripping portion 34, like the flange portion 32 can extend from the outer surface of the sensor mounting portion 31 in the direction perpendicular to the axial direction of the sensor mounting portion 31. The gripping portion 34 can be spaced apart, by a predetermined distance along an axial direction of the sensor holder 30, from the flange portion 32. Accordingly, a portion of the bumper is inserted between the flange portion 32 and the gripping portion 34, such that the sensor holder 30 is secured to the bumper. For example, the gripping portion 34 can be a protrusion that extends radially from the outer surface of the sensor mounting portion 31.

In some examples, after the sensor holder 30 is inserted into the bumper such that the gripping portion 34 penetrates the bumper, when the sensor holder 30 rotates, the gripping portion 34 and the flange portion 32 come into contact with both surfaces of the securing portion 12 formed in the bumper, respectively, such that the sensor holder 30 is secured to the bumper.

In some implementations, the gripping portions 34 can be arranged at intervals along a periphery of the sensor mounting portion 31. Accordingly, when the gripping portion 34 penetrates the bumper and the sensor holder 30 rotates, fastening force is evenly applied along a periphery of the sensor holder 30.

In addition, a molding hole 32a is formed below the gripping portion 34 in the flange portion 32, such that a mold penetrates the flange portion 32 to form the gripping portion 34 during injection-molding of the sensor holder 30.

In some examples, a fastening bolt 50 can be fastened by penetrating the gripping portion 34, thereby secondarily securing the sensor holder 30 to the bumper.

An assembly handle 36 is formed on at least one of the gripping portions 34. The assembly handle 36 is formed to protrude from the gripping portion 34. Since the assembly handle 36 protrudes from the gripping portion 34, an operator can hold the assembly handle 36 and easily rotate the sensor holder 30. Since the operator holds and rotates the assembly handle 36, the sensor holder 30 can be mounted without using a tool.

The assembly handle 36 is formed to be open downward and has a thread 36a formed therein. The fastening bolt 50 that has penetrated the gripping portion 34 is threaded into the thread 36a during the secondary securing of the sensor holder 30.

In some cases, a marker can be formed on an upper surface of the assembly handle 36 to guide an assembly location of the sensor holder 30. A triangular-shaped marker is formed on the upper surface of the assembly handle 36. When the sensor holder 30 is mounted, the sensor holder 30 is rotated until the triangular-shaped marker aligns with another marker formed on the bumper. This enables the operator to easily assemble the sensor holder 30 into a correct location. In particular, the sensor holder 30 can be used universally regardless of the vehicle model and mounting location, and thus by forming a marker on the bumper, the sensor holder 30 can be easily assembled into a predetermined assembly location.

In some implementations, a reinforcing rib 35 can protrude from the gripping portion 34 to reinforce the rigidity of the gripping portion 34. The reinforcing rib 35 is formed to protrude from the gripping portion 34 and extend in a radial direction of the sensor holder 30, i.e., in the direction perpendicular to the axial direction of the sensor mounting portion 31.

In some implementations, a sensor guard 37 can be disposed at an end of the sensor mounting portion 31. An inner surface of the sensor guard 37 is formed to be joined to an inner surface of the sensor mounting portion 31.

When the sensor 40 is mounted in the sensor mounting portion 31, the sensor guard 37 surrounds a periphery of the sensor 40 to assist in mounting the sensor 40 and protect the mounted sensor 40.

In addition, an outer surface of the sensor guard 37 is connected to the gripping portion 34 to support an inner end of the gripping portion 34.

By using the sensor holder 30 having the configuration described above, the sensor 40 is mounted on the bumper.

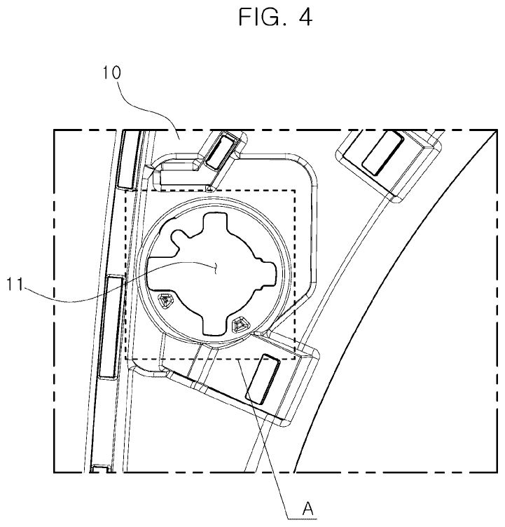

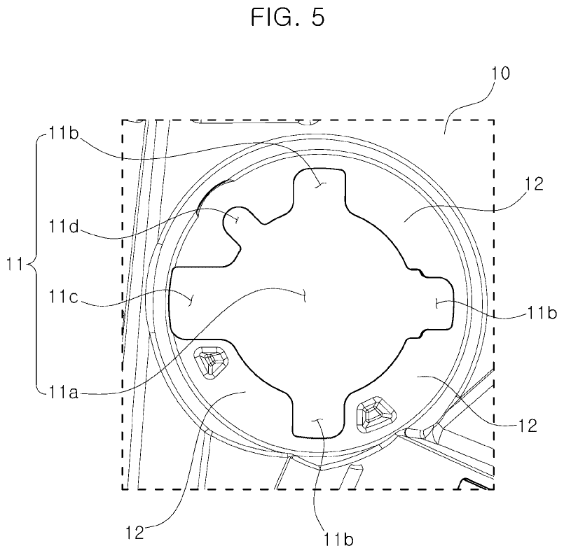

FIGS. 4 and 5 illustrate an example where a sensor mounting hole 11, on which the sensor holder 30 is mounted, is formed in the bumper. The sensor mounting hole 11 includes a main through-hole 11a, which the sensor mounting portion 31 and the sensor guard 37 penetrate, and a sub through-hole 11b, which is located on a periphery of the sensor mounting hole 11 and communicates with the main through-hole 11a. The sub through-hole 11b is penetrated by the gripping portion 34. In addition, a handle through-hole 11c, which the assembly handle 36 penetrates, is formed. The handle through-hole 11c is also located on the periphery of the sensor mounting hole 11 and communicates with the main through-hole 11a. Furthermore, a garnish hook penetration hole 11d, which the fastening bolt 50 penetrates, is formed.

The securing portion 12 is formed to extend from the bumper toward a center of the sensor mounting hole 11. When the sensor holder 30 is inserted into the sensor mounting hole 11 and then rotates, the gripping portion 34 and the flange portion 32 come into contact with both surfaces of the securing portion 12, respectively, such that first securing the sensor holder 30 to the exterior panel 10 of the vehicle.

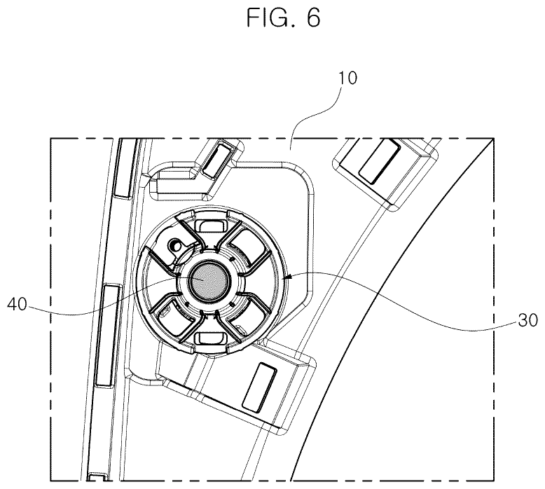

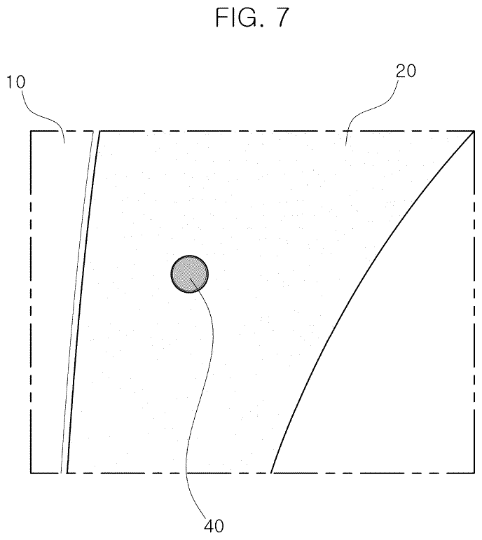

After mounting the sensor 40 on the sensor mounting hole 11 by using the sensor holder 30 (see FIG. 6), finishing with the side garnish 20 is performed such that only a portion of the sensor 40 that detects an object is exposed to the outside (see FIG. 7).

The following is a description of a method of mounting the sensor holder for a vehicle.

The method of mounting the sensor holder for a vehicle includes, as illustrated in FIG. 15, a positioning step in which the sensor holder 30 is positioned to align with the sensor mounting hole 11 formed in the exterior panel 10 of a vehicle (S110), an inserting step in which the sensor holder 30 is inserted into the sensor mounting hole 11 (S120), and a rotating step in which the sensor holder 30 is rotated such that the gripping portion 34 formed in the sensor holder 30 is located in the securing portion 12 formed between the sub through-holes 11b formed on the periphery of the sensor mounting hole 11 (S130).

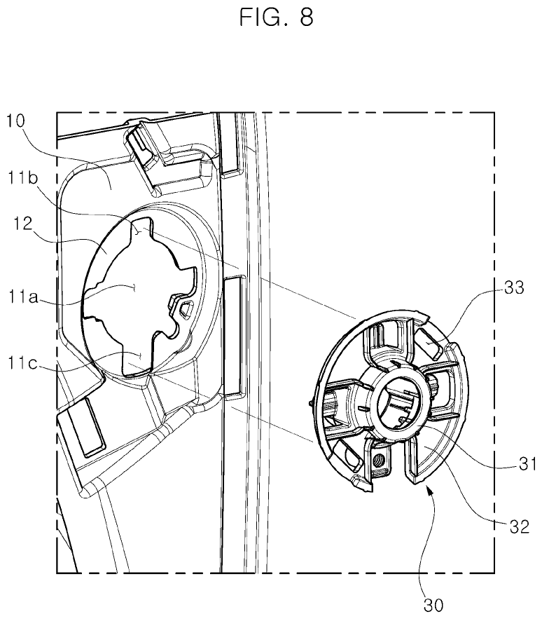

In the positioning step S110, the sensor holder 30 is positioned to align with the sensor mounting hole 11 formed in the exterior panel 10 of the vehicle (see FIG. 8). A shape of the sensor holder 30 is made to match a shape of the sensor mounting hole 11, such that the sensor holder 30 is inserted into the sensor mounting hole 11.

For example, if the sensor holder 30 is to be mounted on the bumper, which is the exterior panel 10 of the vehicle, the sensor holder 30 is positioned such that the shape of the sensor holder 30 matches the shape of the sensor mounting hole 11 formed in the bumper.

The sensor mounting hole 11 is formed to include the main through-hole 11a, which the sensor mounting portion 31 of the sensor holder 30 penetrates, and the sub through-holes 11b, which communicate with the main through-hole 11a and are formed on the periphery of the sensor mounting hole 11 at intervals.

Accordingly, in the positioning step S110, the sensor holder 30 is positioned, such that the gripping portion 34 formed in the sensor holder 30 aligns with the sub through-hole 11b. In addition, the assembly handle 36 formed in the sensor holder 30 is made to align with the handle through-hole 11c formed to communicate with the main through-hole 11a.

In the inserting step S120, the sensor holder 30 is inserted into the sensor mounting hole 11.

With the sensor holder 30 positioned, when the sensor holder 30 is inserted into the sensor mounting hole 11, the sensor mounting portion 31, the gripping portion 34, and the assembly handle 36 penetrate the main through-hole 11a, the sub through-hole 11b, and the handle through-hole 11c, respectively.

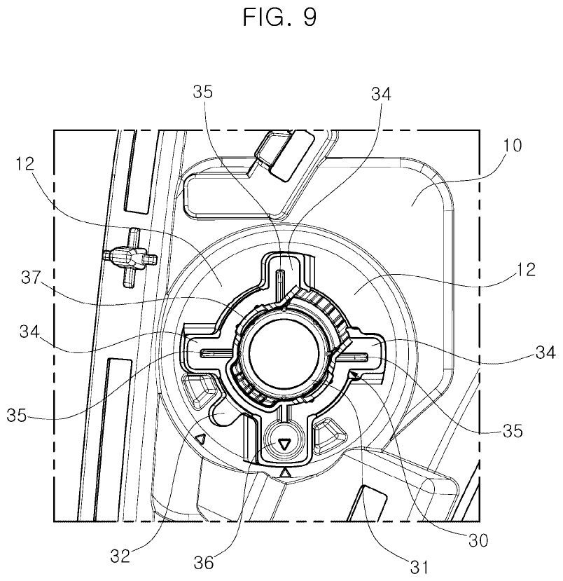

Accordingly, when the inserting of the sensor holder 30 into the sensor mounting hole 11 is completed, the flange portion 32 formed in the sensor holder 30 is seated on the securing portion 12 formed in the exterior panel 10 (see FIG. 9).

In some examples, where markers are formed on the assembly handle 36 and the bumper, respectively, it can be possible to check whether the sensor holder 30 has been inserted into a correct location.

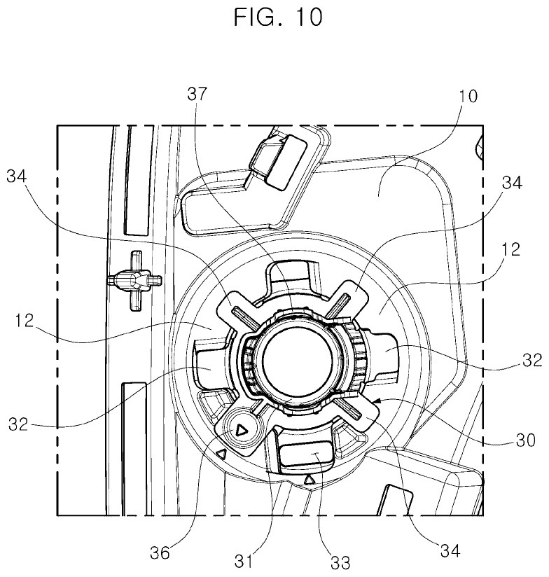

In the rotating step S130, the sensor holder 30 is rotated, such that the gripping portion 34 is located in the securing portion 12 formed between the sub through-holes 11b formed on the periphery of the sensor mounting hole 11 (see FIG. 10).

When the inserting of the sensor holder 30 is completed, and the flange portion 32 is seated on the securing portion 12, the sensor holder 30 is rotated, thereby first securing the sensor holder 30.

When the sensor holder 30 is rotated, the flange portion 32 and the gripping portion 34 come into contact with both surfaces of the securing portion 12, respectively, thereby securing the sensor holder 30 to the exterior panel 10.

The gripping portion 34 is formed to be spaced apart, along the axial direction of the sensor mounting portion 31, from the flange portion 32. Accordingly, by rotating the sensor holder 30, the gripping portion 34 and the flange portion 32 can come into close contact with both surfaces of the securing portion 12, respectively, such that the sensor holder 30 can be secured.

In particular, in the rotating step S130, the sensor holder 30 is rotated, such that the garnish fastening hole 33 formed in the gripping portion 34 aligns with the garnish hook penetration hole 11d. This is to fasten the side garnish 20 through the garnish fastening hole 33 later.

In some examples, where markers are formed on the assembly handle 36 and the bumper, respectively, it can be possible to check whether the sensor holder 30 has rotated to a predetermined location.

In a fastening step S140, the sensor holder 30 is secondarily secured to the exterior panel 10, i.e., the bumper, by using the fastening bolt 50.

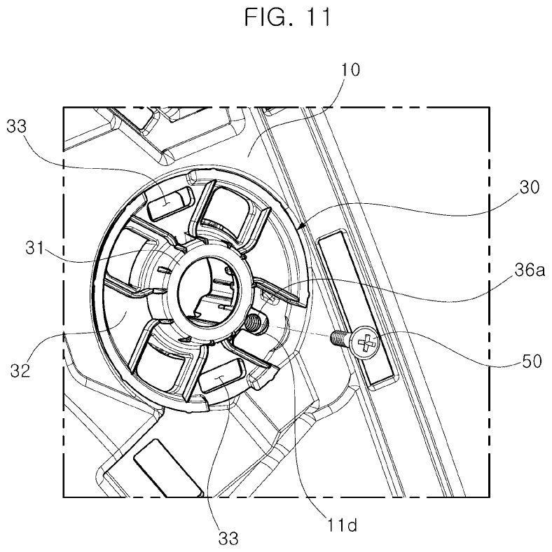

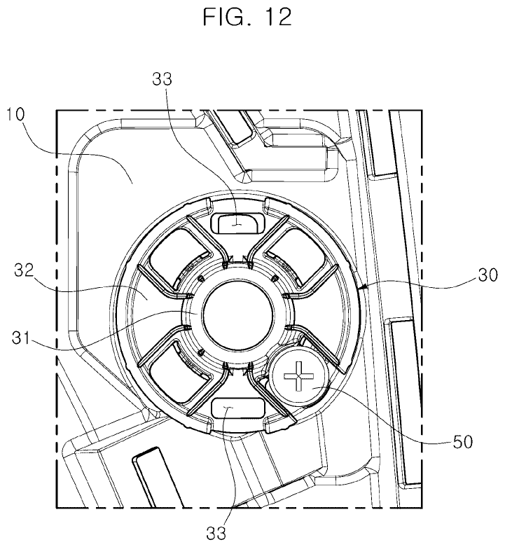

When the fastening bolt 50 penetrates the exterior panel 10 and is fastened to the sensor holder 30, the exterior panel 10 is fit and secured between the sensor holder 30 and the fastening bolt 50. That is, with the fastening bolt 50 located to align with the thread 36a of the assembly handle 36 (see FIG. 11), the fastening bolt is threadedly coupled with the thread 36a of the assembly handle 36 (see FIG. 12).

In some implementations, the sensor holder 30 is secondarily secured to the exterior panel 10, i.e., the bumper, using the fastening bolt 50, thereby completing the mounting of the sensor holder 30.

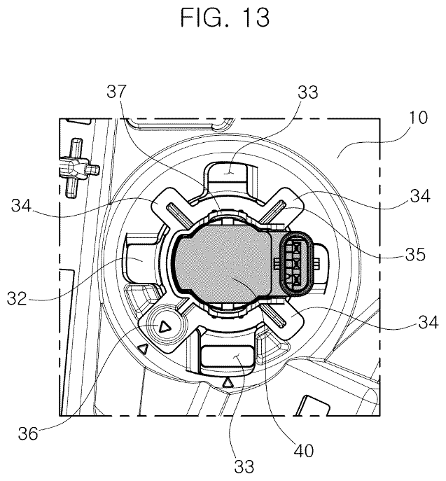

In some implementations, when the mounting of the sensor holder 30 is completed, the sensor 40 is mounted on the sensor holder 30, such that the sensor 40 is located within the sensor mounting portion 31, as illustrated in FIG. 13.

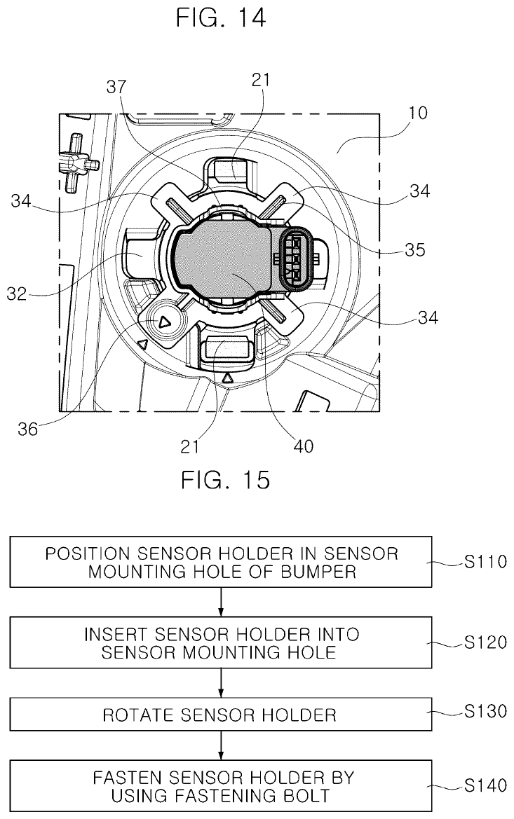

When the mounting of the sensor holder 30 on the sensor holder 30 is completed, the finish part such as the side garnish 20 is secured to the exterior panel 10. When the hook 21 formed in the side garnish 20 penetrates the garnish fastening hole 33 and the garnish hook penetration hole 11d, the hook 21 engages with and is secured to the flange portion 32 of the sensor holder 30 (see FIG. 14). In particular, in the rotating step S130, the sensor holder 30 is rotated such that the garnish fastening hole 33 aligns with the garnish hook penetration hole 11d. Accordingly, the hook 21 can be secured to the flange portion 32 without interfering with the exterior panel 10.

What is claimed is:

1. A sensor holder for a vehicle, the sensor holder comprising:
a sensor mounting portion configured to support a sensor;
a flange portion that extends outward from the sensor mounting portion; and
a gripping portion that extends from the sensor mounting portion and is parallel to the flange portion,
wherein the flange portion and the gripping portion are configured to, based on the gripping portion passing through an exterior panel of the vehicle and then being rotated with respect to the exterior panel, come into contact with surfaces of a securing portion of the exterior panel to thereby fix the sensor holder to the exterior panel of the vehicle.

2. The sensor holder of claim 1, further comprising a fastening bolt that is configured to pass through at least a portion of the gripping portion and be fastened to the gripping portion, the fastening bolt being configured to secondarily fix the sensor holder to the exterior panel of the vehicle.

3. The sensor holder of claim 2, further comprising an assembly handle that protrudes from the gripping portion.

4. The sensor holder of claim 3, wherein the assembly handle defines an opening and a thread in the opening, wherein the fastening bolt is configured to be threadedly coupled to the thread of the assembly handle.

5. The sensor holder of claim 1, further comprising a reinforcing rib that is disposed at the gripping portion and protrudes from the gripping portion.

6. The sensor holder of claim 5, further comprising a sensor guard that is disposed at an end of the sensor mounting portion and configured to surround a periphery of the sensor.

7. The sensor holder of claim 6, wherein the sensor guard is connected to the reinforcing rib.

8. The sensor holder of claim 1, further comprising a plurality of gripping portions that are spaced apart from the flange portion.

9. The sensor holder of claim 8, wherein the plurality of gripping portions are arranged at intervals along a periphery of the sensor mounting portion.

10. The sensor holder of claim 1, wherein the flange portion defines a garnish fastening hole configured to couple to a hook that protrudes from a side garnish of the vehicle, wherein the hook of the side garnish of the vehicle is configured to pass through and engage with the garnish fastening hole.

11. A method for mounting a sensor holder for a vehicle, the method comprising:
positioning the sensor holder to be aligned with a sensor mounting hole defined at an exterior panel of the vehicle;
inserting the sensor holder into the sensor mounting hole; and
rotating the sensor holder relative to the exterior panel to position a gripping portion of the sensor holder to a securing portion of the exterior panel, the securing portion being disposed between sub through-holes that are defined at a periphery of the sensor mounting hole.

12. The method of claim 11, further comprising:
after rotating the sensor holder relative to the exterior panel, fastening the sensor holder to the exterior panel through a fastening bolt.

13. The method of claim 12, wherein fastening the sensor holder to the exterior panel comprises:
inserting the fastening bolt to an opening of an assembly handle of the sensor holder and fastening the fastening bolt to a thread in the opening of the assembly handle.

14. The method of claim 11, wherein positioning the sensor holder comprises aligning the gripping portion with one of the sub through-holes.

15. The method of claim 11, wherein rotating the sensor holder comprises:
rotating the sensor holder to bring the gripping portion and a flange portion of the sensor holder into contact with surfaces of the securing portion of the exterior panel.

16. The method of claim 11, wherein rotating the sensor holder comprises:
rotating the sensor holder to align a garnish fastening hole defined at the sensor holder with one of the sub through-holes.

17. A sensor holder for a vehicle, the sensor holder comprising:
a sensor mounting portion configured to couple a sensor to an exterior panel of the vehicle;
a flange portion that extends from an outer surface of the sensor mounting portion in a radial direction perpendicular to an axial direction of the sensor mounting portion;
a gripping portion that is spaced apart from the flange portion and extends parallel to the flange portion, the gripping portion extending from the sensor mounting portion to an outside of the sensor mounting portion; and
an assembly handle that protrudes from the gripping portion,
wherein the flange portion and the gripping portion are configured to, based on the gripping portion passing through the exterior panel of the vehicle and then the assembly handle being rotated by an operator, come into contact with surfaces of a securing portion of the exterior panel to thereby fix the sensor holder to the exterior panel of the vehicle.

18. The sensor holder of claim 17, further comprising a sensor guard disposed at an end of the sensor mounting portion and configured to cover at least a portion of the sensor.

19. The sensor holder of claim 18, wherein the sensor mounting portion and the sensor guard are configured to pass through a main through-hole that is defined at the exterior panel of the vehicle, and
wherein the gripping portion is configured to pass through a sub through-hole defined at the exterior panel of the vehicle, the sub through-hole being defined at a periphery of the main through-hole and connected to the main through-hole.

20. The sensor holder of claim 19, wherein the assembly handle is configured to pass through a handle through-hole defined at the exterior panel of the vehicle, the handle through-hole being defined at the periphery of the main through-hole and connected to the main through-hole.
